(19) United States
(12) Patent Application Publication
(10) Pub. No.: US 2012/0089289 A1
(43) Pub. Date: Apr. 12, 2012

(54) INTUITIVE FORCE CONTROLLED SYSTEM

(75) Inventors: Asger Gramkow, Augustenborg (DK); Peter Soren Siersbaek Simonsen, Sonderborg (DK)

(73) Assignee: HECARE SYSTEMS APS, Sydals (DK)

(21) Appl. No.: 13/377,421

(22) PCT Filed: Jun. 17, 2010
(86) PCT No.: PCT/DK2010/000095

§ 371 Date: Dec. 9, 2011

(30) Foreign Application Priority Data
Jun. 22, 2009 (DK) PA 2009 00766

(51) Int. Cl. G06F 17/00

(52) U.S. Cl. 701/22

(57) ABSTRACT

The invention relates to a transportation unit (1) such as a wheelchair, a bed, a lift or the like. The transportation unit (1) is configured for transporting a disabled person, and comprises electrically controlled drive means (DM) for controlling and driving one or more wheels (2) of said transportation unit (1), and electric control means (CM) for control of said electrically controlled drive means (DM). The electric control means (CM) comprises a steering handle (3) configured for support of at least one hand of an assisting person. Further, the steering handle (3) is configured for transferring directional orders to an input device (4) of the electric control means (CM) via force restricting means (5). The invention also relates to a method of moving the transportation unit.

### TECHNICAL FIELD

The invention relates to a transportation unit such as a wheelchair, a bed, a lift or the like which is configured for transportation of disabled persons, and a method of moving such transportation units.

### BRIEF DESCRIPTION OF RELATED ART

The need of careful transportation of disabled persons in their home, at hospitals, at nursing homes and the like is important to ensure that the disabled persons are transported from one place to another in an ergonomically correct and gentle way. Therefore numerous transportation units configured for transportation of disabled persons are well known in the art, e.g. lifting units for supporting and moving disabled persons, beds with wheels, wheel chairs and the like. These transportation units are e.g. advantageous in that they reduce the number of necessary movements of the disable persons when the disabled person needs to be transported from one location to another.

A transportation unit configured for transporting the disabled persons may be manually controlled, i.e. moving of the transportation unit is achieved by manually pushing or pulling the transportation units supporting the disabled person. However this solution is disadvantageous since assisting staff has to push the entire weight of the disabled person and the transportation unit, hereby increasing the loads on the assisting staff which may lead to work-related injuries and wear down of the assisting staff Further, this solution is disadvantageous since the disabled person cannot carry out the transportation themselves, and since it is hard for the assisting staff to achieve a precise control of the transportation unit.

A known solution to this problem is to supply the transportation unit with drive means for driving the wheels of the transportation unit. These drive means are controlled by buttons or a joystick facilitating control of the drive means to move the transportation means in one ore more directions. A transportation unit may comprise one or more of these control means, e.g. a joystick or button(s) arranged to be accessible by the disabled person and another joystick or button(s) arranged to be accessible by assisting staff. An example of such a system is found in FIG. 10 of WO 2009/039848 A1.

### BRIEF SUMMARY

The invention seeks to improve the control of a transportation unit configured for transporting and supporting a disabled person and to reduce the load/wear of assisting persons controlling the movement of transportation units transporting and supporting a disabled person.

It has been found by the inventor that assisting staff operating transportation units configured for transporting the disabled persons by means of joystick(s) or button(s) as explained above, finds that the control of the transportation unit is difficult and that the operation of the joystick(s) or button(s) controlling the movement of the transportation unit is an unnatural and unpleasant way of controlling the transportation unit. The reason for this is that the assisting staff has to walk next to or behind the transportation unit during the movement of the transportation unit, and at the same time control the joystick(s) or button(s). This gives the feeling of the transportation unit driving away from the assisting staff operating the transportation unit. This way of control also results in a less precise movement/transportation of the disabled person.

A solution to this problem is therefore a transportation unit such as a wheelchair, a bed, a lift or the like, the transportation unit being configured for transporting a disabled person, said transportation unit comprising:
electrically controlled drive means for controlling and driving one or more wheels of said transportation unit, and
electric control means for control of said electrically controlled drive means,
wherein said electric control means comprises a steering handle configured for support of at least one hand of an assisting person, the steering handle being configured for transferring directional orders to an input device of the electric control means via force restricting means.

By the term “input device” is to be understood e.g. a joystick, i.e. an input device comprising a stick that is pivotable on a base and reports its angle and/or direction to the control means, it may be a button, a group of press-sensitive buttons, a touch panel or the like. The control means may also comprise an input device being one or more wired or wireless remote controls.

By the above is achieved, that since the steering handle transfers directional orders to the input device, and that the force applied by an assisting person to the steering handle is restricted by force restricting means, an intuitive and at the same time cost efficient control of the transportation unit can be achieved while protecting assisting persons from overload. In an aspect of the invention, the steering handle is configured for support of one hand, hereby allowing the assisting person to take further care of the disabled person, e.g. by holding hands with the disabled person. In another embodiment of the invention the steering handle is configured for support of two hands of the assisting person to achieve further intuitive control advantages. The force restriction achieved by the force restricting means which preferably comprises one or more resilient force restricting members as explained later on, likewise facilitates that an assisting person needs to apply a pushing/pulling directional movement/force to the steering handle, thereby giving the feeling that the assisting person pushes/pulls the transportation unit.

It is generally understood that in this document, the force restricting means may also be referred to as force restricting arrangement. Furthermore, it is understood that the control means may also be referred to as control arrangement, and that the drive means may also be referred to as drive arrangement.

By the term “directional force” is to be understood a force applied by the assisting person to the steering handle. In a preferred aspect of the invention, the directional force is configured to be substantially in the horizontal plane preferably substantially in the direction in which the movement of the transportation unit is intended, but in other embodiments of the invention it may also be at least partly in the vertical plane, e.g. in a direction in an angle to the horizontal plane. The directional force applied by the assisting person should preferably be applied in the direction(s) in which the assisting person intend to move the transportation unit, and the directional force is interpreted by the electric control means to control the drive means and hereby the wheels to move the transportation unit in the intended/desired directions.

Further, since the steering handle is configured for support of the whole hand (or hands) of the assisting person, and due to the force restricting means, it makes a more intuitive control of the transportation unit since the steering handle needs the whole arm/body (preferably with a stiff wrist due to a resistance in the handle) to control the transportation unit. This makes the body of the assisting person a natural part of the movement of the transportation unit. A joystick is controlled by soft wrist movements of a hand of an assisting person and makes the control of the transportation unit less intuitive since the assisting person in this way is not a natural part of the movement of the transportation unit as opposed to e.g. manually operated transportation units where the transportation unit is driven solely by manually applied force.

Likewise, the assisting person can benefit from the intuitive control of the transportation unit by using the steering handle, and the assisting person can/may also fine adjust the position of the transportation unit by the input device, which is or may be advantageous e.g. at locations with narrow space. This example may be advantageous where the input device is a joy stick with a stick that that is pivotable on a base and may be controlled by the finger(s) of an assisting person. Thus, both intuitive control of the transportation unit is facilitated by means of the steering handle, and fine adjustment may be facilitated by the joystick.

In a preferred aspect of the invention, the force restricting means are configured for restricting the directional force(s) transferred to the input device.

This facilitates that cost efficient input devices may be used since they do not have to be capable of handling the directional forces of a magnitude of the directional forces applied to the steering handle, and that the steering handle in some embodiment or embodiments may be implemented on existing transportation units without significant redesign of the transportation unit.

In a preferred aspect of the invention, the force restricting means comprises a base member, a force restricting member and a force transferring member, said force transferring member being fixed to said steering handle, being displaceable in relation to said base member and being configured for transferring a first part of said directional force(s) applied to the steering handle to said input device, and transferring a second part of the directional force(s) to said base member through said force restricting member.

By the term “force restricting member” should be understood e.g. one or more resilient members e.g. made of a polymer such as an elastomer, for example rubber, but it may also be coil spring(s), leaf spring(s) or the like, it may be shock absorbing member(s) such as shock absorber(s) comprising a cylinder and a piston, it may be other types of force restricting members or any combinations hereof It is generally understood that the force restricting member is preferably a deformable member who is gradually deformable dependent of the directional force applied to the steering handle, and is preferably capable of returning to its original shape or position after the deformation. The force restricting member may absorb a part of the force and transfer some of the force to the base member It may store some of the force, and/or the like.

The above aspect describes an advantageous and cost efficient mechanical way of restricting the forces transferred to the input device, since one part of the directional force is transferred to the base member, and preferably thereby to the support structure of the transportation unit, and the other part is transferred to the input device.

In a preferred aspect of the invention, the force restricting member is a resilient member such as rubber and is arranged between said base member and said force transferring member to be deformable by said force transferring member.

A resilient member made of e.g. rubber is a cost efficient, space saving and long lasting solution and comprise advantageous mechanical properties. It is however understood that the force restricting member may also be other means than rubber as explained above.

In an aspect of the invention, the force transferring member is displaceable connected to said base part at a first area by means of a first connecting member being secured to either said force transferring member or said base member, and being displaceable within a first through hole or recess of the other of said force transferring member or said base member, said first through hole or recess allowing the first connecting member to be displaced in substantially any direction at least in the horizontal plane within said first through hole or recess.

This is advantageous in that the through hole or recess allows (substantial) horizontal displacement of the connecting member and hereby the force transferring member within the through hole or recess, thereby defining a specific area for allowing displacement of the force transferring member and hereby the steering handle. Likewise, the through hole or recess limits the possible deformation of the force restricting member, thereby protecting the force restricting member, and the through hole or recess may also act as a backup protection of the input device if the steering handle is applied an unnecessarily large force e.g. by the assisting person. The through hole or recess allowing the first connecting member to be displaced in substantially any direction in at least the horizontal plane is preferably arranged between the force restricting member and the input device.

In an aspect of the invention, the force transferring member is displaceable connected to said base part at a second area by means of a second connecting member being secured to either said force transferring member or said base member and being displaceable within a second through hole or recess of the other of said force transferring member or said base member, said second through hole or recess being arranged further away from said input device than said force restricting member and being configured for allowing the second connecting member to be rotatable around an axis and being displaceable substantially in the forward/backward direction of said transportation unit within said second through hole or recess.

Hereby, rotation of the force transferring member is achievable around the said axis, facilitating sideway movement of the force transferring means to achieve sideways control of the input device, in this aspect preferably a joystick. Likewise, the allowed displacement in the forward/backward direction of the transportation unit within the second through hole or recess (preferably achieved by an oblong second through hole or recess) facilitates a more controlled forward/backward control of the input device, and hereby forward/backward control of the transportation unit.

It is generally understood that the mentioned displacement of the connecting members and/or force transferring member is preferably performed/performable in the plane of the surface area of the base member, such as substantially perpendicular to the axis which the second connecting member to be rotatable around.

In an aspect of the invention, the movement speed of the transportation unit is configured to be proportional to the amount of directional force applied to the steering handle by the assisting person, due to the mechanical properties of said force restricting member.

Since the movement speed of the transportation unit may be substantially proportional to the directional force applied to the steering handle by the assisting person, it is possible in an intuitive way to adjust the movement speed of the transportation unit, since the assisting person will experience a way of controlling the movement of the transportation unit which is comparable to control of manual transportation units for disabled persons not comprising electrically controlled drive means for controlling and driving the wheels of the transportation unit. This facilitates a safer and gentler transport of the disabled person. Likewise, it is a cost efficient solution since the adjustable movement speed of the transportation unit is achieved by the mechanical properties of the force restricting member, since the force restricting member (e.g. a resilient member, spring means or the like as explained above) is gradually deformed dependent of the amount of force applied to the steering handle by the assisting person.

In a preferred aspect of the invention, the transportation unit comprises a safety measure such as electronic delay means e.g. implemented in said input device, such as a threshold value for said directional force for determining when to initiate directional orders to said electric drive means, said threshold value being determined by the mechanical properties of said force restricting member, or combinations of said electronic delay means and said threshold value.

The electronic delay means and the threshold value are advantageous in that unintended movement of the transportation unit can be prevented, e.g. if the assisting person by coincidence strikes the steering handle.

Further, the threshold value (which preferably is a limit determining when to achieve an activation of the drive means and hereby a movement of the transportation unit) result in a further advantage in that the threshold value requires a directional force over the threshold to allow movement of the transportation unit. Thereby, the assisting person experiences an intuitive control of the movement of the transportation unit comparable to the control of a manual transportation unit, since the assisting person will experience a static friction as with a fully manual movable transportation unit. It is preferred that the threshold value is not more than a quarter of the threshold value needed to push/pull all the weight of the transportation unit and the disabled person manually. It is most preferred that the threshold value corresponds to that the assisting person has to apply a directional force of at least 2 kg e.g. at least 3 kg such as at least 5 kg to the steering handle to achieve an activation of the drive means and hereby a movement of the transportation unit.

The invention also relates to a method of moving a transportation unit such as a wheelchair, a bed, a lift or the like, said method comprising the steps of:
applying directional orders by an assisting person to a steering handle configured for support of at least one hand of the assisting person,
controlling electrically controlled drive means for controlling and driving one or more wheels of said transportation unit with electric control means,
where the steering handle transfers the directional orders to an input device of the electric control means via force restricting means.

Hereby a cost efficient and intuitive method of controlling the movement of a transportation unit for disabled persons is achieved while the assisting persons controlling the movement of the transportation unit are protected from overload.

### BRIEF DESCRIPTION OF THE FIGURES

The invention will be described in the following with reference to the figures in which:

FIG. 1 illustrates a transportation unit comprising a steering handle according to the invention,

FIG. 1a illustrates a schematic view of an embodiment of the invention,

FIG. 1b illustrates a schematic view of an embodiment of the invention comprising force restricting means,

FIG. 2 illustrates an embodiment of the transportation unit comprising a steering handle and force restricting means seen from above,

FIG. 2a illustrates a cross sectional view of an embodiment of the transportation unit comprising a steering handle and force restricting means seen from the side,

FIG. 3 illustrates an embodiment of control of the movement speed of the transportation unit, dependent of the force applied by an assisting person to the steering handle, and

FIG. 4 illustrates other examples of force restricting means.

### DETAILED DESCRIPTION

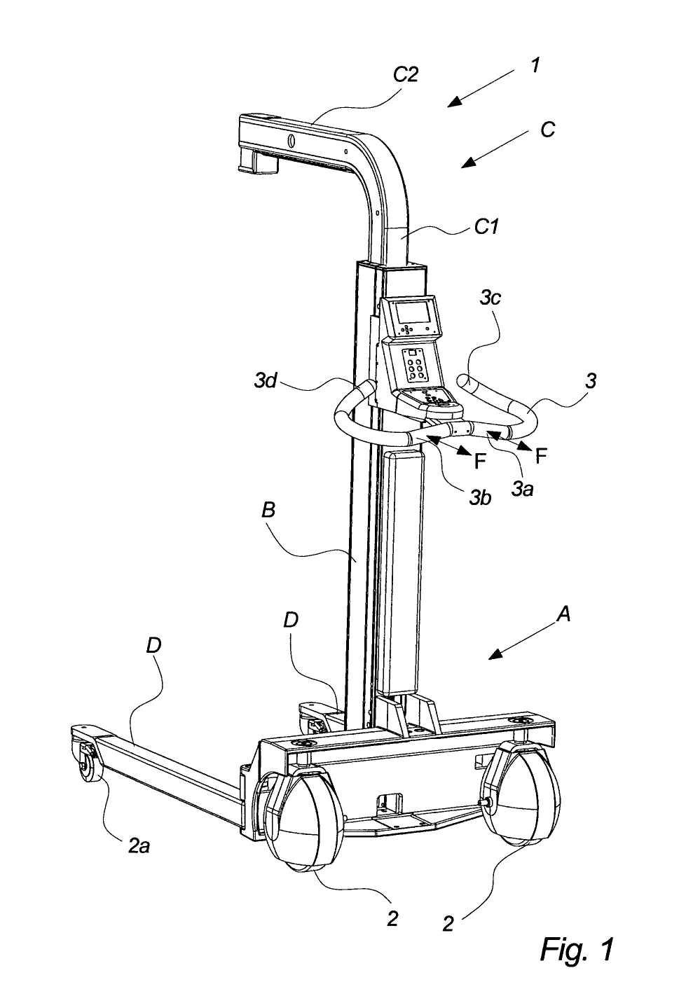

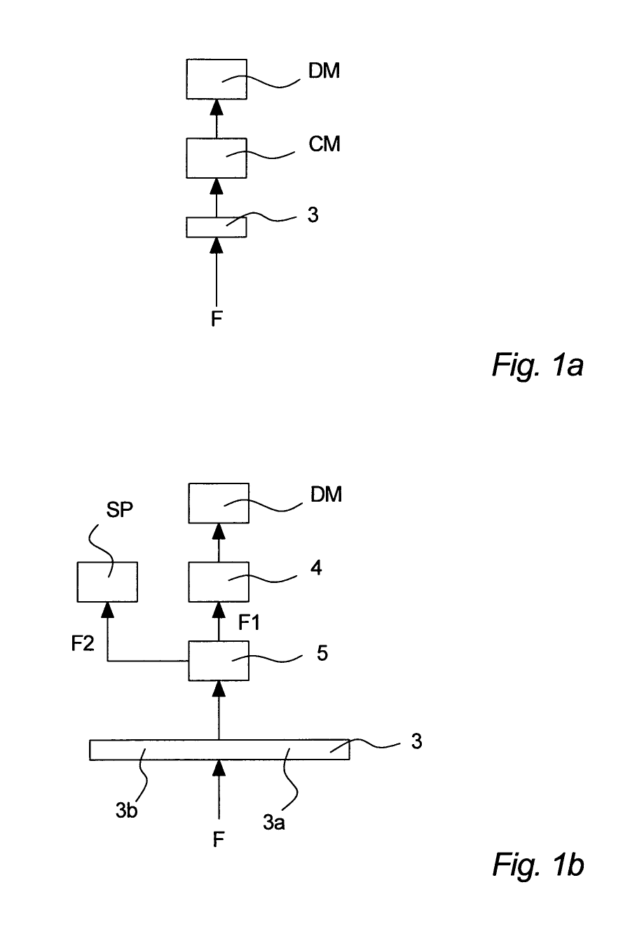

FIG. 1 shows an example of a transportation unit 1 for transporting a disabled person (not illustrated) according to the invention. The transportation unit 1 configured for transporting a disabled person may also in the following be referred to as transportation unit 1.

In FIG. 1, the transportation unit 1 is a lift for transporting a disabled person (not illustrated). The transportation unit 1 comprises a bottom part A supporting a vertical guiding part B for guiding a guided part C comprising a vertical part C1 and a horizontal part C2 with a free end. The lift 1 preferably comprises a supporting part (not illustrated) such as a harness, a chair or the like for supporting and/or fixating a disabled person. This supporting part is supported by the lift by the free end of the horizontal part C2. The supporting part is preferably at least vertically displaceable by one or more supporting wire(s), band(s), string(s), chains or the like, preferably capable of being winded and unwinded to vertically displace the supporting part. The supporting part may also or instead be vertically displaceable by vertically displacing the guided part C. The bottom part A comprises one or more wheels 2 which are controlled by electrically controlled drive means DM (not illustrated) for controlling and driving the one or more wheels 2 of the transportation unit 1. The bottom part A in FIG. 1 further comprises supporting members D comprising additional wheels 2a. It should be understood that the transportation unit 1 in other embodiments of the invention which are not illustrated in any figures may be a bed, a wheelchair or the like. It is of cause understood that a wheelchair also comprises a supporting part, i.e. a chair, and that the supporting part of a bed is a mattress.

The drive means DM comprises means for driving the wheels 2 of the transportation unit 1 such as one or more electric motors, it may comprise transmission(s) facilitating a speed-torque conversion, breaking means for breaking the wheels 2, speed limiting means, means for turning one or more wheels, means for driving one wheel in relation to at least one other wheel (may e.g. be achieved by providing each wheel 2 with an independent electric motor, hereby achieving driving one wheel in one direction while not driving another wheel 2, or while driving another wheel 2 in the other direction), and/or the like.

The transportation unit 1 further comprises electric control means CM (not illustrated in FIG. 1) for control of the electrically controlled drive means DM. The electric control means CM preferably comprise an input device 4 such as a joystick, button(s) or the like as described later on, but it may also be wired or wireless control means capable of receiving signals from a wired or wireless external remote control (not illustrated) and control the electrically controlled drive means DM based on the signals received from the remote control.

The electric control means CM receives control signals comprising directional orders from a further input device being a steering handle 3 which is configured for support of at least one whole hand of an assisting person. It is understood that the steering handle 3 also in other embodiments of the invention may be configured for support of both hands (as illustrated in the drawings) of the assisting person and may comprise two (or more) handle parts 3a, 3b to facilitate support of both hands as illustrated in FIG. 1, but it may also be one large handle (configured for support of one or both hands of the assisting person), preferably with a width above 0.1 meters e.g. above 0.2 meters, such as above 0.3 meters. The steering handle 3 may likewise in embodiments of the invention comprise one or more handle parts 3c, 3d extending forwardly (as illustrated) or backwardly in relation to the transportation unit 1, to facilitate that the assisting person easy and advantageously can cause sideway movements of the transportation unit 1 by pulling or pushing these forwardly or backwardly extending handle parts 3c, 3d in a sideway direction of the transportation unit 1.

It is generally preferred that the electric drive means DM is/are arranged e.g. together with one or more power sources such as a battery or batteries in the bottom part A to achieve a low center of mass. This is advantageous in that the force F applied to the steering handle does not make the transportation unit 1 unstable when the directional force F is applied to the steering handle 3.

FIG. 1a illustrates a schematic view of a preferred embodiment of the invention. As illustrated in FIG. 1, the assisting person applies a directional force F to the steering handle 3. This force F is transferred to the electric control means CM as directional orders, and the electric control means CM controls the electrically controlled drive means DM based on these directional orders to control the wheel(s) 2.

It is understood that directional orders correspond to the directional force F applied to the steering handle 3. As an example, if the assisting person applies a substantially equally distributed forward directed directional force to the steering handle/handle parts 3a, 3b of the steering handle 3, the directional force F would correspond to pushing the transportation unit 1 forward. The electric control means CM receives and interprets these directional order(s) and instructs the electrically controlled drive means DM to control the wheel(s) 2 to initiate a forward movement of the transportation unit 1. Likewise, a substantially equally distributed backward directed force likewise result in the electric control means CM instructing the electrically controlled drive means DM to control the wheel(s) 2 to initiate a backward movement of the transportation unit 1. Further, applying a larger forwardly directed force to the left handle part 3b of the steering handle 3 than the right part 3a of the handle (or applying a force directed partly sideways to the left if the steering handle is configured or support of one hand) would in an embodiment of the invention result in the electric control means CM instructing the electrically controlled drive means DM to control the wheel(s) 2 to initiate a right turn of the transportation unit 1, and applying a larger forwardly directed force to the right handle part 3a of the steering handle 3 than the left handle part 3b of the handle (or applying a force directed partly sideways to the right if the steering handle is configured or support of one hand) would result in the electric control means CM instructing the electrically controlled drive means DM to control the wheel(s) 2 to initiate a left turn of the transportation unit 1. It is generally understood that the above examples preferably are possible both by means of a steering handle 3 configured for support of one hand or both hands of the assisting person.

It is in general further understood that the directional forces F applied by the assisting person to the steering handle 3 to cause a movement of the transportation unit 1, would be interpreted by the electric control means CM and result in the electric control means CM giving orders to the electrically controlled drive means DM to control the wheel(s) 2 to initiate a movement of the transportation unit 1 in a direction that the assisting person would expect from pushing/pulling a manual transportation unit such as a transportation unit without drive means DM for driving wheels of a transportation unit 1.

It is noted, that since the wheels 2 are driven by drive means DM such as one or more electric motors, the directional force F needed to cause the movement of the transportation unit 1 is significantly lower than the force needed to move the weight of a transportation unit (and the disabled person) manually, and the assisting person thereby do not have to manually push/pull the entire weight of the transportation unit and the disabled person.

It is preferred that the steering handle 3 is arranged at the rear end of the transportation unit 1 as illustrated in FIG. 1. This facilitates an advantageous control of the transportation unit 1 during movement of the transportation unit 1 since the assisting person is not positioned in the movement direction of the transportation unit 1 when moving the transportation unit 1 in a forward direction which would be the most common movement direction of the transportation unit 1.

In an embodiment of the invention, the transportation unit 1 comprises decoupling means (not illustrated in any figures) capable of decoupling the electric drive means DM from the wheels 2. These decoupling means may be controlled manually by the assisting person, and facilitates that if one or more of e.g. the electric drive means DM, the electric control means CM, the power supply of the transportation unit 1 powering the electric system of the transportation unit 1 such as the control means CM, drive means DM, display (s), input devices and/or the like, are out of order, the assisting person may still manually move the transportation unit by means of the steering handle 3 which in this case still facilitates very advantageous intuitive control of the movement of the transportation unit 1 at the same way as if the transportation unit 1 was not run out of power or temporarily broken. Hereby, a more safe transportation unit 1 is achieved since advantageous movement of the transportation unit 1 by means of the steering handle 3 is still possible, and the transportation unit 1 does not have to remain at locations in way of others until it is picked up by a vehicle or till it is repaired.

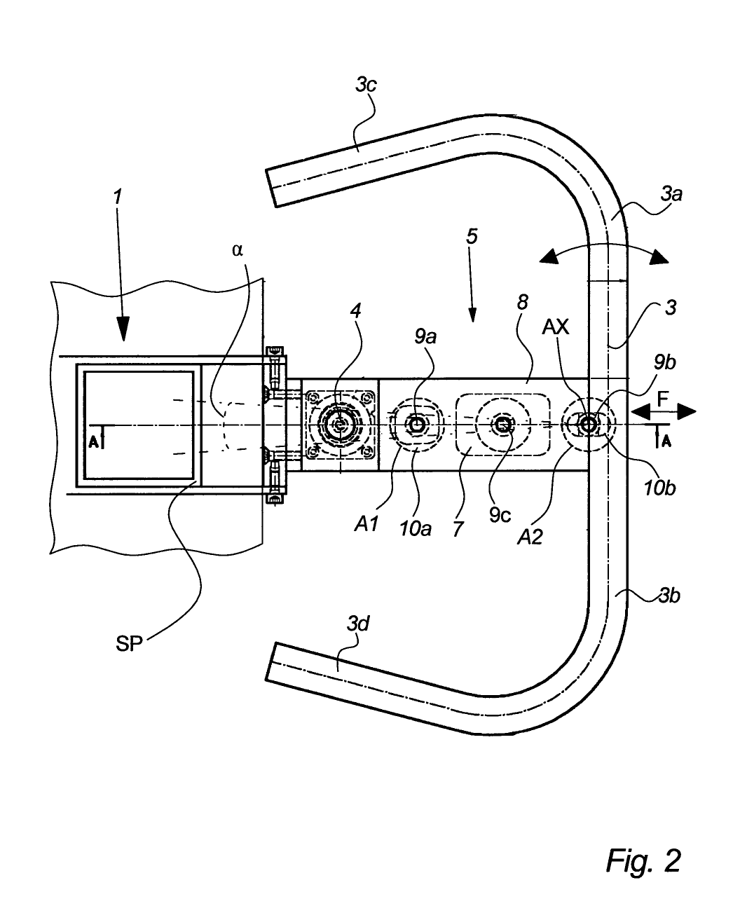

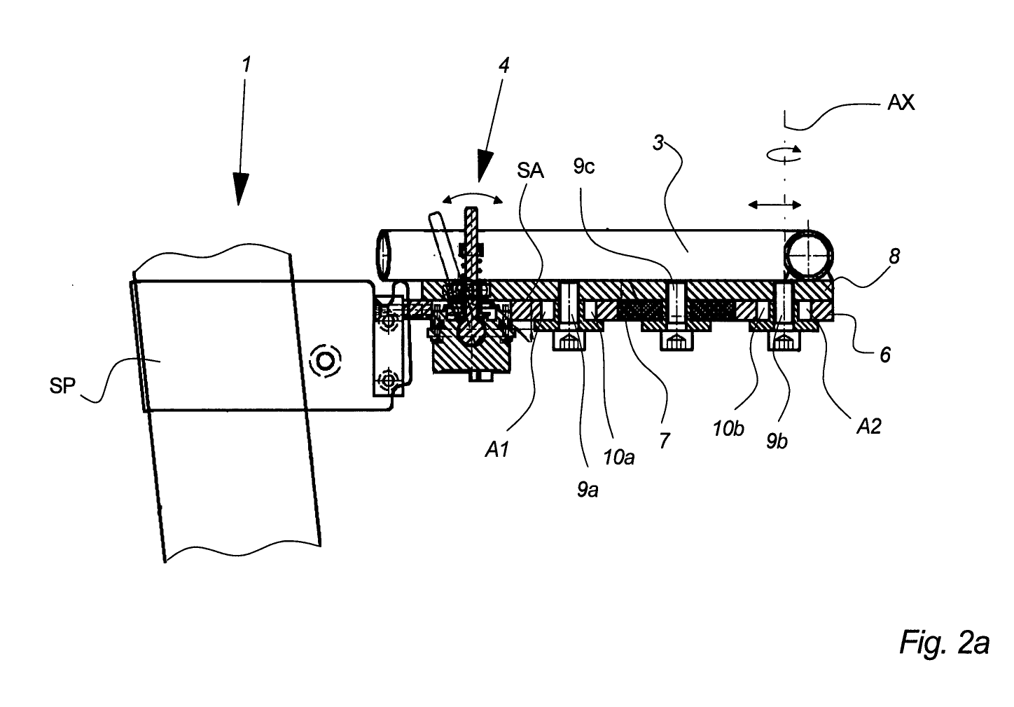

In a preferred embodiment of the invention, the electric control means CM comprises at least one input device 4, arranged on the transportation unit 1 for control of the electrically controlled drive means DM, to increase the control possibilities for an assisting person controlling the transportation unit 1 directly on the transportation unit 2. FIG. 2 illustrates an example of such an embodiment, where the control means CM comprises an input device 4. As mentioned above, the input device 4 is preferably a joystick, i.e. an input device comprising a stick that is pivotable on a base by means of 1, two or three fingers and reports its angle and/or direction to the control means CM as illustrated, but it may also be a press-sensitive button, a group of press-sensitive buttons, a touch panel or the like. A further example of a input device 4 may comprise one or more strain gauge arrangements for detecting the directional force F applied by detecting a change in the electrical resistance.

Further, in a preferred embodiment of the invention, the steering handle 3 is configured for transferring the directional force(s) F applied to the steering handle 3 to the at least one input device 4. The directional force(s) F is/are in this embodiment preferably restricted by force restricting means 5 so as to restrict the force transferred to the at least one input device 4, so that the input device 4 such as a joystick as illustrated, is not overloaded and/or broken.

FIG. 1b illustrates a schematic example of the embodiment in FIG. 2. As illustrated, the assisting person applies a directional force F to the steering handle 3. This force F is transferred to the force restricting means 5, dividing the applied directional force F into a first part F1 transferred to the input device 4, and a second part F2 transferred to e.g. the support structure SP of the transportation unit 1. The input device 4 hereby transfers directional orders to the electric control means CM based on the first part F1 of the force, and the electric control means CM controls the electrically controlled drive means DM based on these directional orders to control the wheel(s) 2.

Examples of the force restricting means 5 are described in more details in the following with reference to FIGS. 2 and 2a which illustrates a cross sectional view of FIG. 2.

In a preferred embodiment of the invention, the force restricting means 5 comprises a base member 6, a force restricting member 7 and a force transferring member 8 fixed to the steering handle 3. The force transferring member 8 is preferably at least partly displaceable in relation to the base member 6 by applying the directional force(s) (F) to the steering handle 3, and transfers a first part F1 of the directional force(s) applied to the steering handle 3 to the input device 4, and a second part F2 of the directional force(s) to the base member 6 through the force restricting member 7. In FIGS. 2 and 2a, the input device 4 is a joystick and the force transferring member 8 is connected to the joystick 4 and transfers the first part F1 of the directional force(s) F applied to the steering handle 3 to the joystick 4 (which in other embodiments may be replaced with buttons, a touch panel or the like as explained above) and pivots the joystick in the desired direction.

As mentioned above, the force transferring member 8 transfers a part of the directional force to the base member 6 through the force restricting member 7. It should be understood that the base member 6 preferably is secured to or is an integrated part of the support structure SP of the transportation unit 1. The force restricting member 7 is in a preferred embodiment of the invention a resilient member arranged between the base member 6 and the force transferring member 8, and may be made of an elastomer such as rubber which is deformable by the force transferring member 8. The elastomer preferably has a hardness between 25 and 80 shore A, e.g. between 40 and 70 shore A, such as between 45 and 65 shore A.

Dependent on the amount of force (F) applied to the steering handle 3 by an assisting person, the force restricting member 7 is gradually deformed by the force transferring means 8 and takes up an amount of force according to the directional force applied to the steering handle 3 due to the material properties of the force restricting member 7. Therefore, the force restricting member 7 substantially linearly restricts the force applied to/transferred to the input device 4, hereby protecting the input device 4.

It is understood that the force restricting member 7, even though an elastomer such as rubber is preferred, may also be/comprise other means capable of restricting the force applied to the input device 4 as explained above, e.g. coil spring(s), shock absorbing member(s) such as shock absorber(s) comprising a cylinder and a piston, or the like.

As shown in the embodiment of the invention illustrated in FIGS. 2 and 2a, the force restricting member 7 may be secured to the base member 6. Further, the force transferring member 8 may be connected to the force restricting member 7 by means of a restricting connection member 9c which is extending substantially through the force restricting member 7 and is secured to the force transferring member 8. Thereby, when directional forces F are applied to the steering handle 3, the restricting connection member 9c will deform the force restricting member 7 thereby restricting the force applied to the input device 4.

In another embodiment of the invention, the force restricting member 7 may be secured to the force transferring member 8, and the restricting connection member 9c may in this embodiment be secured to the base member 6. Thereby, when displacing the force transferring member 8, the force restricting member 7 is deformed, thereby restricting the force applied to the input device 4.

It is generally understood that the restricting connecting member 9c may be an integrated part of the force transferring member 8 or the base member 6, such as an elevating part of the force transferring member 8 or base member 6, it may be a bolt as illustrated in FIGS. 2 and 2a or the like.

In an embodiment of the invention, the force transferring member 8 is displaceable connected to the base part 6 at a first area A1 by means of a first connecting member 9a being secured to either the force transferring member 8 or the base member 6, and being displaceable within a first through hole or recess 10a of the other of the force transferring member 8 or base member 6.

The first through hole or recess 10a, which is larger than the firs connecting member, hereby allows the first connecting member 9a (and hereby the force transferring means) to be displaced in substantially any direction in along the surface area SA (e.g. in the horizontal plane, preferably substantially perpendicular to the axis AX explained below, or in an angle such as between −10° to +10° to the horizontal plane) of the base member 6 within said first through hole or recess 10a. Thereby, the first through hole or recess 10a limits the possible movement of the force transferring member 8 and protects the input device and the force restricting member 7.

The force transferring member 8 may also in an embodiment of the invention be displaceable connected to the base part 6 at a second area A2 by means of a second connecting member 9b being secured to either the force transferring member 8 or the base member 6 and being displaceable within a second through hole or recess 10b of the other of the force transferring member 8 or the base member 6. The second through hole or recess 10b is preferably arranged further away from the input device 4 than the force restricting member 7 and the first through hole or recess 10a, near the steering handle 3, and allows the second connecting member 9b and hereby the force transferring member 8 to be rotatable around an (preferably substantial vertical) axis AX and being displaceable in the second through hole or recess 10b substantially in the forward/backward direction of the transportation unit 1 within the second through hole or recess (10b).

It is understood that the displacement(s) of the first and second connecting members 9a, 9b may comprise displacements of the though holes/recesses 10a 10b in relation to the connecting members, likewise making the connecting members displaceable/displaced within the through holes/recesses 10a, 10b.

The rotation of the force transferring member 8 around the (preferably substantial vertical) axis AX allows sideway control of the input device 4, in this embodiment preferably a joystick, and the first through hole or recess 10a together with the first connecting member 9a (if present) limits the possible rotation of the force transferring means 8/steering handle 3 around the axis AX within a predefined angle α, preferably within a 20° angle e.g. within a 10° angle such as within a 6° angle. This protects the input device 4 and/or the force restricting member 7 since the sideway (and forward/backward) movement of the steering handle 3/force transferring member 8 is kept within a predefined movement area.

It is understood that the first and second through hole or recess 10a, 10b facilitates control of the allowed displacement of the force transferring means 8/steering handle 3, and may act as guiding means for the force transferring means 8.

Further, if the electric drive means DM are decoupled from the wheels 2 to allow the wheels 2 to be moved freely/manually without control from the drive means DM as explained earlier, the through hole or recess 10a and/or 10b together with the first and second connecting members 9a and/or 9b will protect the input device 4 since they restricts/limits the movement of the force transferring member 8, and hence facilitate temporarily manual movement of the transportation unit 1 manually by pushing pulling the steering handle 3, without overloading the input device 4.

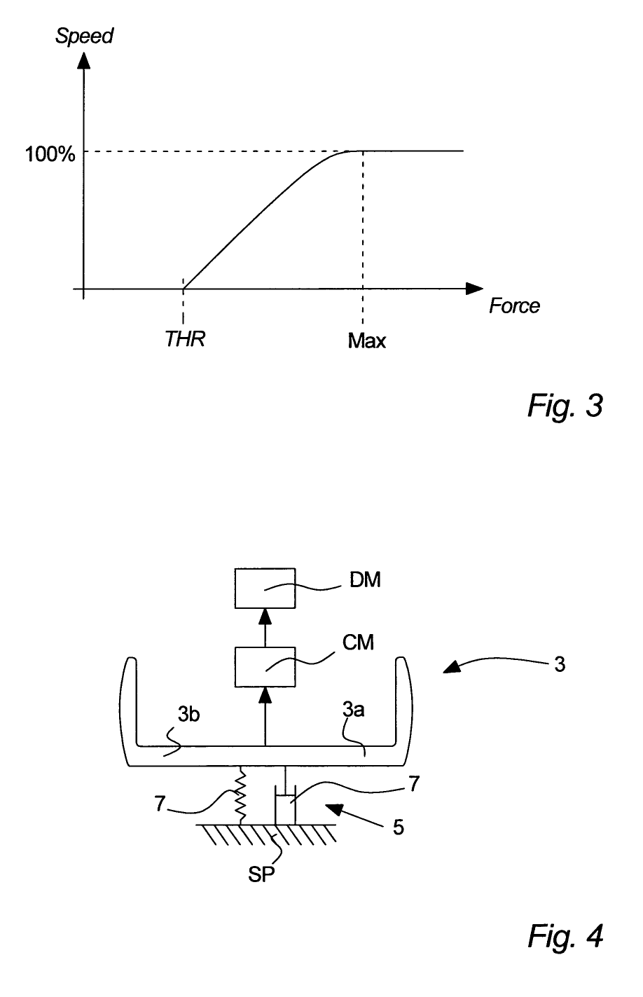

FIG. 3 illustrates an embodiment of the control of the movement of the transportation unit 1. In this embodiment, the electric control means CM are capable of transmitting varying orders regarding the movement speed to the drive means DM dependent on the amount of force F applied to the steering handle 3 and/or the input device 4 e.g. in a interval between 0% and 100%, where 0% corresponds to no force applied, hence the transportation unit is not moving, and 100% (Max) whereby the transportation unit is moving with the maximum speed.

Further, FIG. 3 illustrates a preferred embodiment of the invention wherein the transportation unit 1 comprises a safety measure to avoid unintentional movements of the transportation unit 1. The safety measure may comprise that the assisting person has to apply a force to the steering handle 3 over a threshold THR, e.g. as illustrated in FIG. 3, before the electric drive means DM receives signals from the electric control means CM to initiate the wheels 2 to move. This threshold THR may e.g. be determined by the mechanical properties of the force restricting member 7, but it may also be determined based on the needed amount of force applied to the input device 4 to achieve an output from the input device 4, it may be a threshold value THR set in/by software, or the like. It is of cause understood that the threshold THR may also be present without facilitating variable speed of the transportation unit 1 dependent on the force applied to the steering handle 3, so that the transportation unit 1 may move with a substantially constant speed when the force applied to the steering handle is over the threshold THR.

The safety measure may also (or instead) comprise electronic delay means e.g. implemented in the input device (4), in software or the like. These electronic delay means facilitates that the steering handle 3 (and/or the input device 4) has to be activated for a certain amount of time, e.g. 1-2 seconds, before the drive means DM are activated.

FIG. 4 illustrates another embodiment of the invention, wherein the force restricting means 5 comprises one or more force restricting member(s) 7 such as one or more spring means e.g. coil spring(s), flat spring(s) or the like and/or damping means such as e.g. shock absorber(s) comprising a cylinder and a piston, or the like. It is understood that the force restriction may be achieved by compressing the spring(s), stretching the spring(s), pushing or pulling the piston in the cylinder, and/or the like. It is further understood that the force restricting member 7 may comprise any combination of spring(s) damper(s), elastomer(s) such as rubber and/or the like.

It will be understood that the invention is not limited to the particular examples described above but may be designed in a multitude of varieties within the scope of the invention, as specified in the claims.

1. A transportation unit such as a wheelchair, a bed, a lift or the like, the transportation unit being configured for transporting a disabled person, said transportation unit comprising:
an electrically controlled drive arrangement for controlling and driving one or more wheels of said transportation unit, and
an electric control arrangement for control of said electrically controlled drive arrangement,
wherein said electric control arrangement comprises a steering handle configured for support of at least one hand of an assisting person,
the steering handle being configured for transferring directional orders to an input device of the electric control arrangement via a force restricting arrangement.

2. The transportation unit according to claim 1, wherein said force restricting arrangement is configured for restricting the directional force(s) transferred to the input device-.

3. The transportation unit according to claim 1, wherein said force restricting arrangement comprises a base member, a force restricting member and a force transferring member, said force transferring member being fixed to said steering handle, being displaceable in relation to said base member and being configured for transferring a first part of said directional force(s) applied to the steering handle to said input device, and transferring a second part of the directional force(s) to said base member through said force restricting member.

4. The transportation unit according to claim 3, wherein said force restricting member is a resilient member such as rubber and is arranged between said base member and said force transferring member to be deformable by said force transferring member.

5. The transportation unit according to claim 4, wherein said force transferring member is displaceable connected to said base part at a first area by means of a first connecting member being secured to either said force transferring member or said base member, and being displaceable within a first through hole or recess of the other of said force transferring member or said base member, said first through hole or recess allowing the first connecting member to be displaced in substantially any direction at least in the horizontal plane within said first through hole or recess.

6. The transportation unit according to claim 3, wherein said force transferring member is displaceable connected to said base part at a second area by means of a second connecting member being secured to either said force transferring member or said base member and being displaceable within a second through hole or recess of the other of said force transferring member or said base member, said second through hole or recess being arranged further away from said input device than said force restricting member and being configured for allowing the second connecting member to be rotatable around an axis and being displaceable substantially in the forward/backward direction of said transportation unit within said second through hole or recess.

7. The transportation unit according to claim 3, wherein the movement speed of the transportation unit is configured to be proportional to the amount of directional force applied to the steering handle by the assisting person, due to the mechanical properties of said force restricting member.

8. The transportation unit according to claim 1, comprising a safety measure comprising electronic delay arrangement implemented in said input device.

9. A method of moving a transportation unit such as a wheelchair, a bed, a lift or the like, said method comprising the steps of:
applying directional orders by an assisting person to a steering handle configured for support of at least one hand of the assisting person,
controlling an electrically controlled drive arrangement for controlling and driving one or more wheels of said transportation unit with an electric control arrangement,
where the steering handle transfers the directional orders to an input device of the electric control arrangement via a force restricting arrangement.

10. The transportation unit according to claim 1, comprising a safety measure comprising a threshold value for said directional force for determining when to initiate directional orders to said electric drive means, said threshold value being determined by the mechanical properties of said force restricting member.

11. The transportation unit according to claim 1, comprising a safety measure comprising a combination electronic delay arrangement implemented in said input device and a threshold value for said directional force for determining when to initiate directional orders to said electric drive means, said threshold value being determined by the mechanical properties of said force restricting member.
